(19) United States
(12) Patent Application Publication
(10) Pub. No.: US 2005/0273809 A1
(43) Pub. Date: Dec. 8, 2005

(54) Apparatus and method for providing user selectable alert modes for a television signal receiver

(75) Inventors: Scott Allan Kendall, Westfield, IN (US); Gavin Lee Johnston, Indianapolis, IN (US); John Douglas Merrell, Noblesville, IN (US)

Correspondence Address: THOMSON LICENSING INC., PATENT OPERATIONS, PO BOX 5312, PRINCETON, NJ, 08543-5312, US

(73) Assignee: THOMSON LICENSING S.A., F-92100 BOULOGNE-BILLANCOURT (FR)

(21) Appl. No.: 10/519,036

(22) PCT Filed: Jun. 19, 2003
(86) PCT No.: PCT/US03/19519

§ 371 Date: Dec. 22, 2004

(51) Int. Cl. H04N 7/025; H04N 7/10

(52) U.S. Cl. 725/33

(57) ABSTRACT

A television signal receiver (having an emergency alert function provides an alert output in accordance with a user selectable alert mode corresponding to the type of emergency event. According to an exemplary embodiment, the television signal receiver includes a tuner operative to tune a frequency including emergency alert signals indicating a type of emergency event. A processor is operative to enable an alert output responsive to the emergency alert signals, wherein the alert output is provided in accordance with a user selectable alert mode corresponding to the type of emergency event.

The present invention generally relates to television signal receivers, with or without a display device, and more particularly, to television signal receivers having an emergency alert function capable of, among other things, providing an alert output in accordance with a user selectable alert mode corresponding to the type of emergency event. The present invention further relates to user interfaces associated with the emergency alert function.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain specialized radios and scanners are capable of receiving emergency alert signals provided by the NWS and NOAA. However, such devices tend to be dedicated to this use, and generally offer consumers little, if any, functionality beyond monitoring these signals. Accordingly, in order to receive advance warning of weather-related emergencies, consumers are required to purchase a separate, dedicated device, which may be cost-prohibitive to some consumers.

Another problem with such devices is their failure to provide consumers with options regarding the manner in which they are alerted in specific emergency situations. For example, certain devices detect emergency events by receiving Specific Area Message Encoding (SAME) data which indicates the specific geographical area(s) affected by the emergency event, the type of emergency event (e.g., tornado, toxic chemical spill, radiation leak, civil emergency, etc.), and the expiration time of the event alert. With such devices, when an emergency event occurs, an alert output such as an audio message may be provided to alert individuals of the emergency event. While such devices may allow users to select the type of alert output provided in emergency events, the selected type or mode of alert output is used for every type of emergency event. In other words, such devices do not allow consumers to designate the manner in which they are alerted on an event-by-event basis.

The use of a common alert mode for every type of emergency event as described above may be confusing and even dangerous for consumers since they may be unable to readily determine from the alert output whether the particular emergency event is one which may require immediate action (e.g., tornado warning), or one which may be ignored (e.g., thunderstorm watch). Moreover, the use of a common alert mode for every type of emergency event may tend to desensitize consumers towards alert outputs in general since all alert outputs may appear to be similar or the same. As a result, consumers may be more likely to ignore alert outputs and thereby expose themselves to dangerous conditions.

Accordingly, there is a need for a device capable of receiving emergency alert signals which avoids the foregoing problems. The present invention addresses these and other issues.

In accordance with an aspect of the present invention, a television signal receiver having an emergency alert function is disclosed. According to an exemplary embodiment, the television signal receiver comprises tuning means for tuning a frequency including emergency alert signals indicating a type of emergency event. Processing means enable an alert output responsive to the emergency alert signals, wherein the alert output is provided in accordance with a user selectable alert mode corresponding to the type of emergency event.

In accordance with another aspect of the present invention, a method for controlling a television signal receiver having an emergency alert function is disclosed. According to an exemplary embodiment, the method comprises steps of tuning a frequency including emergency alert signals indicating a type of emergency event, and providing an alert output responsive to the emergency alert signals, wherein the alert output is provided in accordance with a user selectable alert mode corresponding to the type of emergency event.

The above-mentioned and other features and advantages of this invention, and the manner of attaining them, will become more apparent and the invention will be better understood by reference to the following description of embodiments of the invention taken in conjunction with the accompanying drawings, wherein:

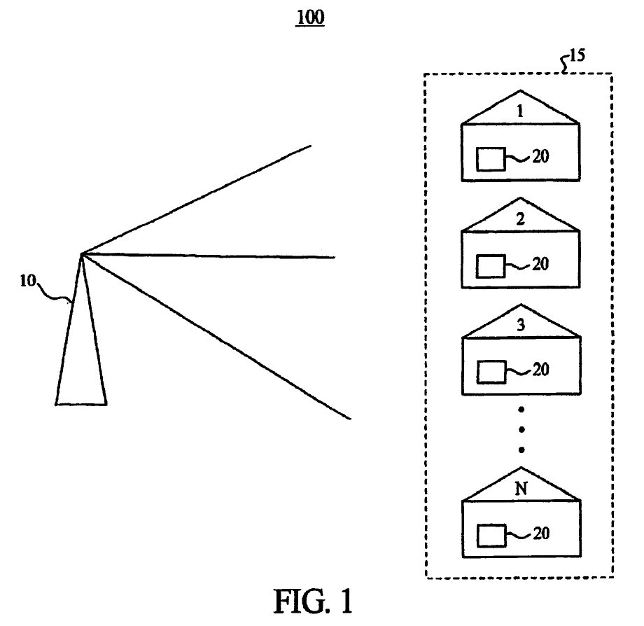

FIG. 1 is an exemplary environment suitable for implementing the present invention;

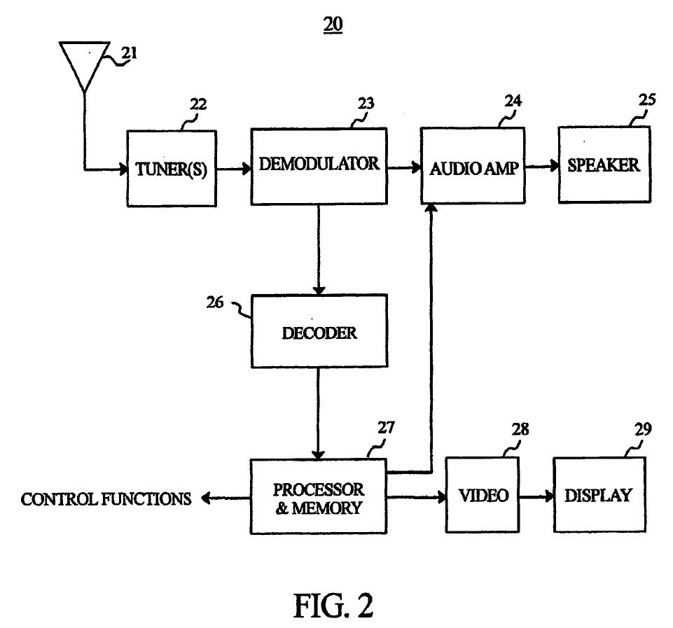

FIG. 2 is a block diagram of a television signal receiver according to an exemplary embodiment of the present invention;

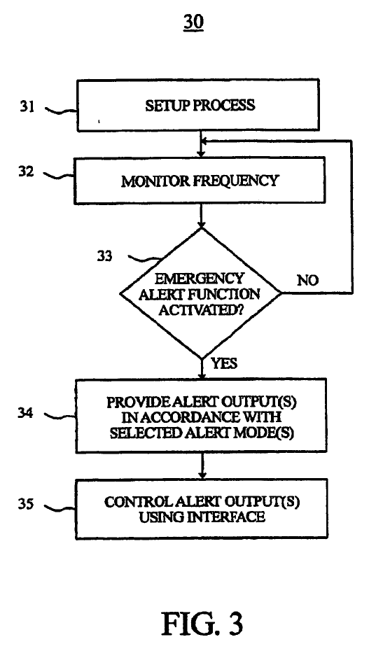

FIG. 3 is a flowchart illustrating exemplary steps according to the present invention;

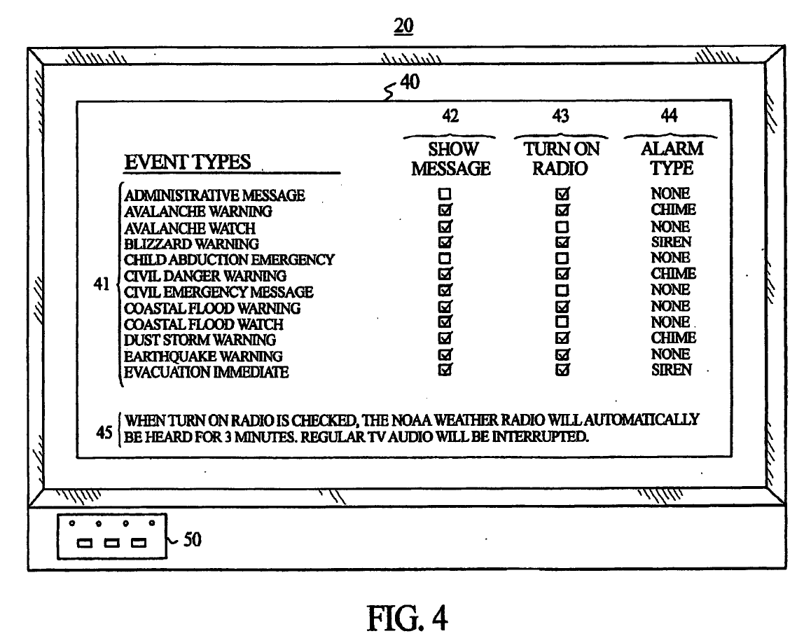

FIG. 4 is another diagram of a television signal receiver including user interfaces according to an exemplary embodiment of the present invention; and

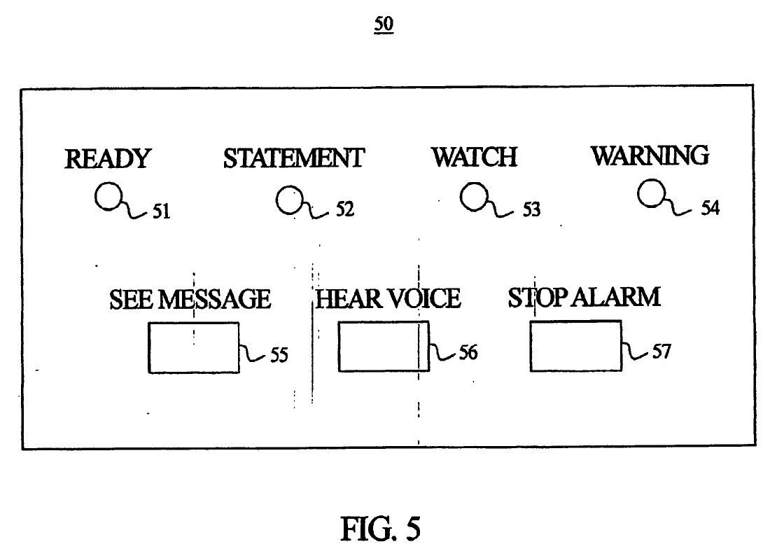

FIG. 5 is a diagram showing further exemplary details of one of the user interfaces of FIG. 4.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as television signal receivers 20.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables television signal receiver 20 to receive emergency alert signals and provide one or more alert outputs to notify individuals of an emergency event. As will be discussed later herein, television signal receiver 20 is also capable of providing one or more alert outputs in accordance with one or more user selectable alert modes corresponding to the type of emergency event.

According to an exemplary embodiment, signal transmission source 10 transmits signals including emergency alert signals which may be received by each television signal receiver 20. The emergency alert signals may be provided from an authority such as the NWS, or other authorities such as governmental entities or the like. In response to the emergency alert signals, each television signal receiver 20 may provide one or more alert outputs to thereby notify individuals of the emergency event. Signal transmission source 10 may transmit such emergency alert signals to television signal receivers 20 via any wired or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements of television signal receiver 20 including control signals may not be shown in FIG. 2.

Signal receiving element 21 is operative to receive signals including audio and/or video signals from signal sources, such as signal transmission source 10 in FIG. 1. According to an exemplary embodiment, received audio signals may include digitally encoded emergency alert signals. Signal receiving element 21 may be embodied as any signal receiving element such as an antenna, input terminal or other element.

Tuner 22 is operative to tune signals including audio and/or video signals. According to an exemplary embodiment, tuner 22 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may include digitally encoded emergency alert signals.

Demodulator 23 is operative to demodulate signals provided from tuner 22. According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to a control signal provided from processor 27. Speaker 25 is operative to aurally output the amplified audio signals provided from audio amplifier 24.

Decoder 26 is operative to decode signals including audio and/or video signals. According to an exemplary embodiment, decoder 26 decodes audio signals provided from demodulator 23 to thereby extract digitally encoded frequency shift keyed (FSK) signals, which represent emergency alert signals indicating an emergency event. According to this exemplary embodiment, the emergency alert signals include data comprising SAME data associated with the emergency event. SAME data comprises a digital code representing information such as the specific geographical area affected by the emergency event, the type of emergency event (e.g., tornado, toxic chemical spill, radiation leak, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of television signal receiver 20 allows a user to select items such as an applicable geographical area(s), and type(s) of emergency events (e.g., tomado, toxic chemical spill, radiation leak, civil emergency, etc.) which activate the emergency alert function.

When the emergency alert function of television signal receiver 20 is activated, processor 27 outputs one or more control signals which enable various operations. According to an exemplary embodiment, such control signals enable one or more alert outputs (e.g., aural and/or visual) to thereby notify individuals of the emergency event. According to the present invention, such alert outputs are provided in accordance with user selectable alert modes corresponding to the particular type of emergency event. Such control signals may also enable other operations of television signal receiver 20, such as causing it to be switched from an off/standby mode to an on mode.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays. Display 29 is operative to provide visual displays corresponding to processed signals provided from video processor 28. According to an exemplary embodiment, display 29 may provide visual displays including the aforementioned messages that provide details regarding emergency events.

Turning now to FIG. 3, a flowchart 30 illustrating exemplary steps according to the present invention is shown. For purposes of example and explanation, the steps of FIG. 3 will be described with reference to television signal receiver 20 of FIG. 2. The steps of FIG. 3 are merely exemplary, and are not intended to limit the present invention in any manner.

At step 31, a setup process for the emergency alert function of television signal receiver 20 is performed. According to an exemplary embodiment, a user performs this setup process by providing inputs to television signal receiver 20 (e.g., using a remote control device not shown) responsive to an on-screen menu displayed via display 29. Such an on-screen menu may for example be part of an electronic program guide (EPG) function of television signal receiver 20. According to an exemplary embodiment, the user may select at least the following items during the setup process at step 31:
A. Enable/Disable—The user may select whether to enable or disable the emergency alert function.
B. Frequency Selection—The user may select the monitoring frequency to tune to in order to receive emergency alert signals. For example, the user may select a frequency such as one of the following NWS transmission frequencies: 162.400 MHz, 162.425 MHz, 162.450 MHz, 162.475 MHz, 162.500 MHz, 162.525 MHz and 162.550 MHz.
C. Event Types—The user may select one or more types of emergency events which activate the emergency alert function. For example, the user may designate that events such as civil emergencies, acts of war, and/or tornado warnings activate the emergency alert function, but that events such as thunderstorm warnings do not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.
D. Geographical Areas—The user may select one or more geographical areas of interest. For example, the user may select a particular continent, country, region, state, area code, zip code, city, county, municipality, subdivision, and/or other definable geographical area.
E. Alert Modes—The user may select one or more alert modes for each type of emergency event that activates the emergency alert function. According to an exemplary embodiment, the user may select visual and/or aural outputs to be provided for each type of emergency event that activates the emergency alert function. For example, the user may select to display a visual message (e.g., an NWS text message as a closed caption display) and/or tune television signal receiver 20 to a specific channel. The user may also for example select to aurally output a warning tone (e.g., chime, siren, etc.) and/or an audio message (e.g., NWS audio message), and the desired volume of each. Other types of alert outputs may also be provided according to the present invention.

The user selections of items C and E at step 31 may be combined in a single user interface, such as user interface 40 shown in FIG. 4. Referring to FIG. 4, another diagram of television signal receiver 20 including user interfaces 40 and 50 according to exemplary embodiments of the present invention is shown. In particular, FIG. 4 illustrates exemplary user interface 40 that may be used to select items C and E of step 31, and also shows another exemplary user interface 50 which may be used to control alert outputs and will be described later herein with reference to FIG. 5.

In FIG. 4, user interface 40 comprises a list of event types 41 (i.e., item C), user selectable alert modes 42 to 44 corresponding to event types 41 (i.e., item E), and an exemplary on-screen message 45. According to an exemplary embodiment, a user may interact with user interface 40 (e.g., using a remote control device not shown) and thereby select one or more alert modes 42 to 44 for each of the event types 41. The user may also toggle back and forth among various screens to view different event types 41. The particular event types 41, alert modes 42 to 44, and on-screen message 45 shown in user interface 40 of FIG. 4 are examples only, and different event types, alert modes, and on-screen messages may be used according to the present invention.

As indicated in FIG. 4, user selection of alert modes 42 and 43 causes a check mark to appear in the row corresponding to the particular event type 41. Similarly, user selection of alert mode 44 causes the term “CHIME” or “SIREN” to appear in the row corresponding to the particular event type 41. Also in FIG. 4, if a user does not want a particular event type 41 to activate the emergency alert function of television signal receiver 20, then alert modes 42 and 43 are not selected (i.e., no check marks), and alert mode 44 is set to “NONE” (e.g., CHILD ABDUCTION EMERGENCY). In this manner, user interface 40 enables users to designate both: (1) event types that activate the emergency alert function (i.e., item C of step 31), and (2) corresponding alert modes for each event type that activates the emergency alert function (i.e., item E of step 31). Accordingly, user interface 40 enables users to designate the alert output(s) provided by the emergency alert function of television signal receiver 20 on an event-by-event basis.

According to the present invention, other menu selections than those expressly described herein may also be provided at step 31. Data corresponding to the user's selections during the setup process of step 31 is stored in memory 27 under the control of processor 27.

At step 32, television signal receiver 20 monitors the frequency selected by the user during the setup process of step 31 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content.

At step 33, a determination is made regarding whether the emergency alert function of television signal receiver 20 is activated. According to an exemplary embodiment, processor 27 makes this determination by comparing data included in the incoming emergency alert signals to data stored in memory 27 from the setup process of step 31. As previously indicated herein, the emergency alert signals may include data such as SAME data which represents information including the type of emergency event (e.g., tomado, toxic chemical spill, radiation leak, civil emergency, etc.) and the specific geographical area(s) affected by the emergency event. According to an exemplary embodiment, processor 27 compares this SAME data to the corresponding data from the setup process of step 31 (i.e., items C and D) stored in memory 27 to thereby determine whether the emergency alert function is activated. In this manner, the emergency alert function of television signal receiver 20 is activated only when the emergency event indicated by the emergency alert signals corresponds to the geographical area(s) and/or event type(s) designated by the user at step 31.

If the determination at step 33 is negative, process flow loops back to step 32 where tuner 22 continues to monitor the selected frequency. Alternatively, if the determination at step 33 is positive, process flow advances to step 34 where television signal receiver 20 provides one or more alert outputs in accordance with the one or more alert modes selected by the user at step 31 (i.e., item E), to thereby notify individuals of the emergency event. As previously indicated herein, such alert outputs may be visual and/or aural in nature. For example, a visual message such as an NWS text message may be provided as a closed caption display via display 29 in accordance with the user selections during the setup process of step 31. Aural outputs such as a chime, siren or the like and/or an audio message such as an NWS audio message or a message from the All Hazards Alert System may also be provided at step 34 via speaker 25 in accordance with the user selections during the setup process of step 31.

According to an exemplary embodiment, at least one alert output that is not based on a user selection at step 31 may also be provided at step 34. For example, an alert output may be provided via indicator elements on a front display panel of television signal receiver 20 to notify individuals of an emergency event. Further details regarding this type of alert output will be provided below with reference to step 35. Other types of aural and/or visual alert outputs than those expressly described herein may also be provided at step 34 according to the present invention.

At step 35, a user may control the alert output(s) using an interface, such as exemplary user interface 50 of FIG. 4. As indicated in FIG. 4, user interface 50 may be included on a front display panel of television signal receiver 20. User interface 50 may also be included separately from the front display panel of television signal receiver 20, and may for example be provided on another device such as a remote control device of television signal receiver 20. Referring now to FIG. 5, a diagram providing further details of exemplary user interface 50 is shown. As indicated in FIG. 5, user interface 50 comprises indicator means such as indicator elements 51 to 54, and control means such as control elements 55 to 57.

According to an exemplary embodiment, indicator elements 51 to 54 are operative to provide users with visual information regarding the emergency alert function of television signal receiver 20, and may for example be embodied as light-emitting diode (LED) elements, liquid crystal display (LCD) elements, liquid quartz display (LQD) elements, and/or other visual indicator elements. According to an exemplary embodiment, indicator elements 51 to 54 may be used provide an alert output that is not based on a user selection at step 31. That is, indicator elements 51 to 54 may be used to provide users with visual information every time the emergency alert function is activated, and may not be completely turned off by users. In this manner, indicator elements 51 and 54 ensure that users are provided with at least one alert output when the emergency alert function is activated. For purposes of example, user interface 50 of FIG. 5 is shown as having four indicator elements. However, the number of such indicator elements used in practice may be a matter of design choice according to the present invention.

According to an exemplary embodiment, indicator element 51 may exhibit a green color and be illuminated when the emergency alert function of television signal receiver 20 is operational and emergency alert signals are being received. Indicator elements 52 to 54 may also exhibit different colors and be illuminated to provide visual information regarding emergency events. For example, indicator element 52 may exhibit a yellow color and be illuminated to indicate a statement or advisory level alert. Similarly, indicator element 53 may exhibit an orange color and be illuminated to indicate a watch level alert, and indicator element 54 may exhibit a red color and be illuminated to indicate a warning level alert. As previously indicated herein, these different alert levels may represent different emergency events according to the present invention. Other colors than those described above, and/or different labels for indicator elements 51 to 54 than those shown in FIG. 5 may also be used according to the present invention.

According to an exemplary embodiment, indicator elements 52 to 54 may flash (e.g., 4 flashes per second with equal intervals of light and dark) when the emergency alert function is activated, rather than remain steadily illuminated, since flashing or blinking lights are generally better to gain a user's attention. However, a combination of flashing and steady illumination may also be used according to the present invention. For example, if a statement level alert occurs, indicator element 52 may initially blink to attract a user's attention. This blinking may continue for a predetermined time period, or until the user provides an input to television signal receiver 20 such as an input via one of the control elements 55 to 57. Once the predetermined time period elapses or the user provides an input, indicator element 52 may become steadily illuminated. Indicator elements 53 and 54 may operate in a similar manner for watch level alerts and warning level alerts, respectively. Other techniques for combining flashing and steady illumination of indicator elements 52 to 54 may also be used according to the present invention.

Also according to an exemplary embodiment, control elements 55 to 57 are operative to enable user control of the alert output(s) of television signal receiver 20, and may for example be embodied as keys, buttons, and/or other control elements which enable users to control the alert output(s) of television signal receiver 20. For purposes of example, user interface 50 of FIG. 5 is shown as having three control elements. However, the number of such control elements used in practice may be a matter of design choice according to the present invention.

According to the exemplary embodiment shown in FIG. 5, control element 55 operates as a toggle switch and may be manipulated by a user to turn on and off a visual message such as an NWS text message provided as a closed caption display via display 29. For example, if a visual message is on display 29, control element 55 may be used to turn that message off. Alternatively, if there is no visual message on display 29, but the emergency alert function is activated (e.g., one of indicator elements 52 to 54 is blinking), then control element 55 may be used to turn on the visual message and thereby cause it to be displayed on display 29. In this manner, control element 55 may be used to turn on and off an alert output for a given occurrence of a particular emergency event. Moreover, if television signal receiver 20 is in the off/standby mode, control element 55 may be used to switch television signal receiver 20 to the on mode and turn on the visual display.

According to an exemplary embodiment, control element 56 may also operate as a toggle switch in a manner similar to control element 55 described above. In particular, control element 56 may be manipulated by a user to turn on and off an audio message such as an NWS audio message or a message from the All Hazards Alert System provided via speaker 25. For example, if an audio message is being provided via speaker 25, control element 56 may be used to turn that message off. Alternatively, if no audio message is being provided, but the emergency alert function is activated (e.g., one of indicator elements 52 to 54 is blinking), then control element 56 may be used to turn on the audio message and thereby cause it to be output via speaker 25. In this manner, control element 56 may be used to turn on and off an alert output for a given occurrence of a particular emergency event. Moreover, if television signal receiver 20 is in the off/standby mode, control element 56 may be used to switch television signal receiver 20 to the on mode and turn on the audio message.

According to an exemplary embodiment, control element 57 may be manipulated by a user to turn off an alarm such as a chime, siren or the like provided via speaker 25. For example, if an alarm is activated, control element 57 may be used to turn the alarm off. According to an exemplary embodiment, control elements 55 and 56 may also be used to turn off the alarm. As previously indicated herein, there may be three different settings for such an alarm: off, chime, or siren (see alert mode 44 of user interface 40 in FIG. 4). According to an exemplary embodiment, the chime is a gentle but recognizable sound, while the siren is a loud and urgent sound. Such an alarm may for example start at a given volume level and gradually increase to a maximum volume level established by a user. Accordingly, by allowing users to turn off the alarm using any of the control elements 55 to 57, the present invention advantageously enables users to quickly turn off the alarm before it becomes too annoying.

As previously indicated herein, it is preferred that control elements 55 to 57 not be used to completely turn off indicator elements 51 to 54 to ensure that users are provided with at least one alert output when the emergency alert function is activated. Other labels for control elements 55 to 57 than those shown in FIG. 5 may also be used according to the present invention. Accordingly, user interface 50 of FIG. 5 is only an example and other types of indicators, displays and/or control means may be provided according to the present invention.

As described herein, the present invention provides a television signal receiver having an emergency alert function capable of, among other things, providing an alert output in accordance with a user selectable alert mode corresponding to the type of emergency event. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A television signal receiver having an emergency alert function, comprising:
a tuner operative to tune a frequency including emergency alert signals indicating a type of emergency event; and
a processor operative to enable an alert output responsive to the emergency alert signals, wherein the alert output is provided in accordance with a user selectable alert mode corresponding to the type of emergency event.

2. The television signal receiver of claim 1, further comprising an interface operative to enable a user to turn the alert output on and off.

3. The television signal receiver of claim 1, wherein the processor is further operative to enable a plurality of alert outputs responsive to the emergency alert signals, and the plurality of alert outputs are provided in accordance with a plurality of user selectable alert modes corresponding to the type of emergency event.

4. The television signal receiver of claim 3, wherein at least one of the plurality of alert outputs is a visual output.

5. The television signal receiver of claim 3, wherein at least one of the plurality of alert outputs is an aural output.

6. The television signal receiver of claim 3, further comprising an interface operative to enable a user to turn at least one of the plurality of alert outputs on and off.

7. The television signal receiver of claim 6, wherein at least one of the plurality of alert outputs can not be completely turned off by a user.

8. A television signal receiver having an emergency alert function, comprising:
tuning means for tuning a frequency including emergency alert signals indicating a type of emergency event; and
processing means for enabling an alert output responsive to the emergency alert signals, wherein the alert output is provided in accordance with a user selectable alert mode corresponding to the type of emergency event.

9. The television signal receiver of claim 8, further comprising interface means for enabling a user to turn the alert output on and off.

10. The television signal receiver of claim 8, wherein the processing means enables a plurality of alert outputs responsive to the emergency alert signals, and the plurality of alert outputs are provided in accordance with a plurality of user selectable alert modes corresponding to the type of emergency event.

11. The television signal receiver of claim 10, wherein at least one of the plurality of alert outputs is a visual output.

12. The television signal receiver of claim 10, wherein at least one of the plurality of alert outputs is an aural output.

13. The television signal receiver of claim 10, further comprising interface means for enabling a user to turn at least one of the plurality of alert outputs on and off.

14. The television signal receiver of claim 13, wherein at least one of the plurality of alert outputs can not be completely turned off by a user.

15. A method for controlling a television signal receiver having an emergency alert function, comprising:
tuning a frequency including emergency alert signals indicating a type of emergency event; and
providing an alert output responsive to the emergency alert signals, wherein the alert output is provided in accordance with a user selectable alert mode corresponding to the type of emergency event.

16. The method of claim 15, further comprised of enabling a user to turn the alert output on and off.

17. The method of claim 15, further comprised of providing a plurality of alert outputs responsive to the emergency alert signals, and the plurality of alert outputs are provided in accordance with a plurality of user selectable alert modes corresponding to the type of emergency event.

18. The method of claim 17, wherein at least one of the plurality of alert outputs is a visual output.

19. The method of claim 17, wherein at least one of the plurality of alert outputs is an aural output.

20. The method of claim 17, further comprised of enabling a user to turn at least one of the plurality of alert outputs on and off.

21. The method of claim 20, wherein at least one of the plurality of alert outputs can not be completely turned off by a user.
